(19) United States
(12) Patent Application Publication
(10) Pub. No.: US 2025/0348610 A1
(43) Pub. Date: Nov. 13, 2025

(54) METHODS AND SYSTEMS FOR SECURE SOFTWARE DELIVERY

(71) Applicant: GUARDANT HEALTH, INC., Palo Alto, CA (US)

(72) Inventors: Sitaraman Suthamali LAKSHMINARAYANAN, Palo Alto, CA (US); William Patrick BAIRD, Orinda, CA (US); Mark ALAN RICE, JR., Palo Alto, CA (US); Narsi RAJAGOPALAN, Redwood City, CA (US); Jason Richard ST. JOHN, Houston, TX (US); Mikhail ZHAGROV, San Francisco, CA (US)

(21) Appl. No.: 19/221,319

(22) Filed: May 28, 2025

Related U.S. Application Data
(63) Continuation of application No. PCT/US2023/081631, filed on Nov. 29, 2023.
(60) Provisional application No. 63/385,377, filed on Nov. 29, 2022.

(51) Int. Cl. G06F 21/62; H04L 9/32

(52) U.S. Cl. CPC G06F 21/6218; H04L 9/321

(57) ABSTRACT

Methods, systems, and apparatuses for securely delivering software artifacts. A first computing device may be configured to encrypt one or more software artifacts into an encrypted data file and encrypt a key and a policy file associated with the encrypted data file and send the encrypted data file, key, and policy file to a second computing device. The policy file may comprise policy information for authenticating access to the encrypted data file. The second computing device may use the key and the policy information to access and authenticate a software application of the second computing device. The software application may be used to decrypt the data file and access the one or more software artifacts.

### CROSS-REFERENCE TO RELATED APPLICATIONS

The present application is a Continuation of International Patent Application No. PCT/US2023/081631, filed Nov. 29, 2023, which claims the benefit of, and relies on the filing date of, U.S. provisional patent application No. 63/385,377, which was filed Nov. 29, 2022, the entire disclosure of which is incorporated herein by reference.

### BACKGROUND

Air-gapped machines typically include computing systems or servers that are physically disconnected (air-gap open) from other machines or a network, and thus, preventing attempts for remote attack against the air-gapped machine. Conventional software, or data, delivery methods that utilize air-gapped systems involve the use of transferring data between the computing systems via a portable storage device. These methods rely on encrypting data before storing the data on the portable storage device and public/private keys, used to decrypt and access the data, being protected manually or by reliance on access controls. Conventional encryption systems support operations in which data is encrypted in a way where it can be decrypted only by users with a unique decryption key. For symmetric key encryption systems, such as Advanced Encryption Standard (AES), the encryption and decryption keys are the same, and every effort must be made to prevent leaking the keys to adversaries allowing the adversaries to gain the ability to decrypt and access sensitive data. For public key encryption systems, such as RSA, a paired public key and secret key are used such that data, once encrypted with a public key, can only be decrypted with its corresponding secret key. If an adversary obtains the public key, the adversary would still not be able to decrypt the data. However, the individual computing devices are still vulnerable to software attacks, such as malware attacks. These computing devices may be compromised, where malware may gain access to the devices and access the key(s) used to decrypt the associated data.

### SUMMARY

It is to be understood that both the following general description and the following detailed description are exemplary and explanatory only and are not restrictive.

Methods, systems, and apparatuses for providing secure software delivery are described herein. A secure build server may be configured to encrypt one or more software artifacts (e.g., data files, container images, bioinformatics (such as genomic, epigenomic, and/or proteomic data from a patient test sample), etc.) into an encrypted data file and encrypt a first key and a policy file associated with the encrypted data file. The policy file may comprise policy information authenticating access to the encrypted data file. The secure build server may store the encrypted first key via a trusted execution environment and the encrypted data file and policy file via a portable storage. A destination server may access the portable storage to receive the encrypted data file, the encrypted policy file, and the encrypted first key. The destination server may use a second key to decrypt an encrypted software application, the encrypted policy file, and the encrypted first key. The destination server may authenticate the software application based on the policy information and use the software application and the first key to decrypt the encrypted data file and access the one or more software artifacts.

In an embodiment, disclosed are methods comprising encrypting, by a first computing device, one or more software artifacts into an encrypted data file, encrypting an encryption key and a policy file associated with the encrypted data file, wherein the policy file comprises policy information for authenticating access to the encrypted data file, storing the encrypted encryption key via a trusted execution environment of the first computing device, and storing the encrypted data file and the policy file via portable storage, wherein a second computing device accesses the encrypted data file via a software application of the second computing device that is authenticated based on the encryption key and the policy information.

In an embodiment, disclosed are methods comprising receiving, by a computing device, an encrypted data file, an encrypted policy file, and an encrypted first encryption key, decrypting, based on a second encryption key, an encrypted software application, the encrypted policy file, and the encrypted first encryption key, wherein the policy file comprises policy information for authenticating access to the encrypted data file, authenticating, based on the policy information, the software application, decrypting, via the software application, based on the authentication of the software application and based on the first encryption key, the encrypted data file, and accessing, based on the decrypted data file, one or more software artifacts.

In an embodiment, disclosed are systems comprising first computing device comprising a trusted execution environment, wherein the first computing device is configured to encrypt one or more software artifacts into an encrypted data file, encrypt a first encryption key and a policy file associated with the encrypted data file, wherein the policy file comprises policy information for authenticating access to the encrypted data file, store the encrypted first encryption key via the trusted execution environment, store the encrypted data file and the policy file via portable storage, a second computing device configured to decrypt, based on a second encryption key, an encrypted software application, the encrypted policy file, and the encrypted first encryption key, authenticating, based on the policy information, the software application, decrypting, via the software application, based on the authentication of the software application and based on the first encryption key, the encrypted data file, and accessing, based on the decrypted data file, the one or more software artifacts.

The various steps of the methods disclosed herein, or the steps carried out by the systems disclosed herein, may be carried out at the same time or different times, and/or in the same geographical location or different geographical locations, e.g., countries. The various steps of the methods disclosed herein can be performed by the same person/entity or different people/entities.

Additional advantages will be set forth in part in the description which follows or may be learned by practice. The advantages will be realized and attained by means of the elements and combinations particularly pointed out in the appended claims.

### BRIEF DESCRIPTION OF THE DRAWINGS

The accompanying drawings, which are incorporated in and constitute a part of the present description serve to explain the principles of the methods and systems described herein:

FIG. 1 shows an example system;

FIG. 2 shows an example scenario;

FIG. 3 shows an example encryption/decryption process;

FIG. 4 shows an example encryption/decryption process;

FIG. 5 shows a flowchart of an example method; and

FIG. 6 shows a flowchart of an example method.

### DETAILED DESCRIPTION

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another configuration includes from the one particular value and/or to the other particular value. Similarly, when values are expressed as approximations, by use of the antecedent “about,” it will be understood that the particular value forms another configuration. It will be further understood that the endpoints of each of the ranges are significant both in relation to the other endpoint, and independently of the other endpoint.

“Optional” or “optionally” means that the subsequently described event or circumstance may or may not occur, and that the description includes cases where said event or circumstance occurs and cases where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal configuration. “Such as” is not used in a restrictive sense, but for explanatory purposes.

It is understood that when combinations, subsets, interactions, groups, etc. of components are described that, while specific reference of each various individual and collective combinations and permutations of these may not be explicitly described, each is specifically contemplated and described herein. This applies to all parts of this application including, but not limited to, steps in described methods. Thus, if there are a variety of additional steps that may be performed it is understood that each of these additional steps may be performed with any specific configuration or combination of configurations of the described methods.

As will be appreciated by one skilled in the art, hardware, software, or a combination of software and hardware may be implemented. Furthermore, the methods and systems may take the form of a computer program product on a computer-readable storage medium (e.g., non-transitory) having processor-executable instructions (e.g., computer software) embodied in the storage medium. Any suitable computer-readable storage medium may be utilized including hard disks, CD-ROMs, optical storage devices, magnetic storage devices, memresistors, Non-Volatile Random Access Memory (NVRAM), flash memory, or a combination thereof.

Throughout this application reference is made to block diagrams and flowcharts. It will be understood that each block of the block diagrams and flowcharts, and combinations of blocks in the block diagrams and flowcharts, respectively, may be implemented by processor-executable instructions. These processor-executable instructions may be loaded onto a general purpose computer, special purpose computer, or other programmable data processing apparatus to produce a machine, such that the processor-executable instructions which execute on the computer or other programmable data processing apparatus create a device for implementing the functions specified in the flowchart block or blocks.

These processor-executable instructions may also be stored in a computer-readable memory that may direct a computer or other programmable data processing apparatus to function in a particular manner, such that the processor-executable instructions stored in the computer-readable memory produce an article of manufacture including processor-executable instructions for implementing the function specified in the flowchart block or blocks. The processor-executable instructions may also be loaded onto a computer or other programmable data processing apparatus to cause a series of operational steps to be performed on the computer or other programmable apparatus to produce a computer-implemented process such that the processor-executable instructions that execute on the computer or other programmable apparatus provide steps for implementing the functions specified in the flowchart block or blocks.

Blocks of the block diagrams and flowcharts support combinations of devices for performing the specified functions, combinations of steps for performing the specified functions and program instruction means for performing the specified functions. It will also be understood that each block of the block diagrams and flowcharts, and combinations of blocks in the block diagrams and flowcharts, may be implemented by special purpose hardware-based computer systems that perform the specified functions or steps, or combinations of special purpose hardware and computer instructions.

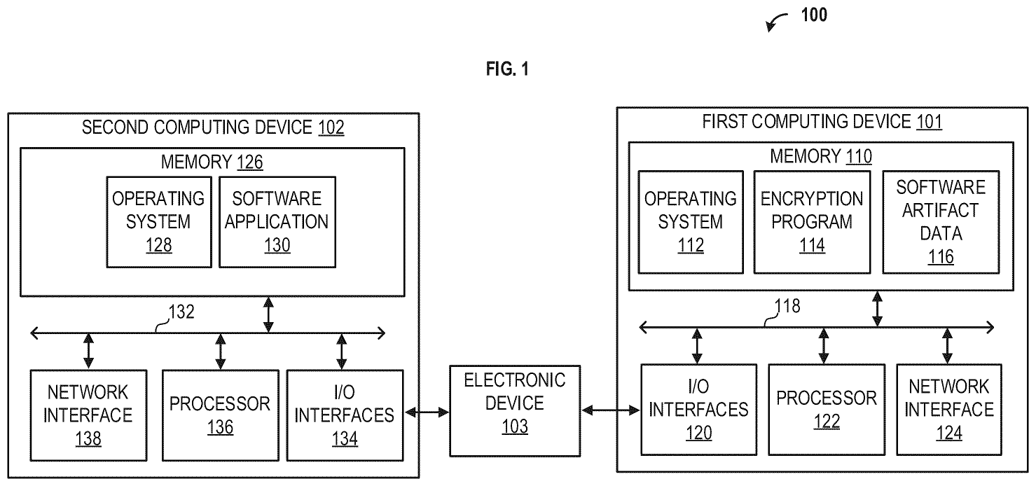

FIG. 1 shows an example system 100 for securely transferring software. In an example, some or all steps of any described method may be performed on a computing device as described herein. The system may include a first computing device 101, a second computing device 103, and an electronic device 103. The first computing device 101 may comprise a server computing device (e.g., a secure build server). For example, the first computing device 101 may comprise a digital computer. The digital computer may comprise memory 110, one or more input/output (I/O) interfaces 120, a processor 122, and one or more network interfaces 124. The memory 110, the one or more input/output (I/O) interfaces 120, the processor 122, and the one or more network interfaces 124 may be in communication with each other via a local interface 118. The local interface 118 may comprise one or more buses or other wired or wireless connections. The local interface 118 may comprise additional elements, which are omitted for simplicity, such as controllers, buffers (caches), drivers, repeaters, and receivers, to enable communications. The local interface 118 may further include address, control, and/or data connections to enable appropriate communications among the memory 110, the one or more input/output (I/O) interfaces 120, the processor 122, and the one or more network interfaces 124.

The one or more I/O interfaces 120 may comprise one or more interfaces for receiving user input from, and/or for providing system output to, one or more devices or components. User input may be provided via, for example, a keyboard and/or a mouse. System output may be provided via a display device and a printer (not shown). I/O interfaces 120 may include, for example, a serial port, a parallel port, a Small Computer System Interface (SCSI), an infrared (IR) interface, a radio frequency (RF) interface, and/or a universal serial bus (USB) interface. In an example, at least one of the one or more I/O interfaces 120 may be configured to connect to an electronic device 103. The electronic device 103 may comprise a portable storage device comprising one or more of USB storage, secure digital storage, a mobile device, a smart phone, a tablet, or any other computing device capable of communicating with the first computing device 101 and/or the second computing device 102 and storing data/information.

The processor 122 may be a hardware device for executing software, particularly that may be stored in the memory 110. The processor 122 may be any custom made or commercially available processor, a central processing unit (CPU), an auxiliary processor among several processors associated with the first computing device 101, a semiconductor-based microprocessor (in the form of a microchip or chip set), or generally any device for executing software instructions. When the first computing device 101 is in operation, the processor 122 may be configured to execute software stored within the memory 110, to communicate data to and from the memory 110, and to generally control operations of the first computing device 101 pursuant to the software. In an example, the processor 122 may further include a trusted execution environment comprising a hardware-based memory encryption (e.g., Intel Software Guard Extensions (SGX) CPU). The trusted execution environment may be used to store a key for encrypting/decrypting data. For example, the first computing device 101 may generate a public-private key pair for encrypting/decrypting data. The first computing device 101 may store the public key via the trusted execution environment and the private key via portable storage (e.g., USB storage, secure digital storage. In an example, the first computing device 101 may be configured to send the private key to a destination server via a secure back-haul network.

The one or more network interfaces 124 may be used to transmit and receive data from the first computing device 101 via a network (e.g., intranet, extranet, Internet, secure back-haul network, etc.). The network interface 124 may include, for example, a 10BaseT Ethernet Adaptor, a 100BaseT Ethernet Adaptor, a LAN PHY Ethernet Adaptor, a Token Ring Adaptor, a wireless network adapter (e.g., WiFi, cellular, satellite), or any other suitable network interface device. The one or more network interfaces 124 may include address, control, and/or data connections to enable appropriate communications on the network.

The memory 110 may include any one or combination of volatile memory elements (e.g., random access memory (RAM, such as DRAM, SRAM, SDRAM, etc.)) and nonvolatile memory elements (e.g., ROM, hard drive, tape, CDROM, DVDROM, etc.). Moreover, the memory 110 may incorporate electronic, magnetic, optical, and/or other types of storage media. Note that the memory 110 may have a distributed architecture, wherein various components are situated remote from one another, but may be accessed by the processor 122.

The software in the memory 110 may include one or more software programs, each of which comprises an ordered listing of executable instructions for implementing logical functions. The software in the memory system 110 of the first computing device 101 may comprise an operating system (O/S) 112, an encryption program 114, and software artifact data 116. The operating system 112 may control the execution of other computer programs and provide scheduling, input-output control, file and data management, memory management, and communication control, and related services. For example, the first computing device 101 may receive one or more software artifacts (e.g., data files, container images, or bioinformatics) and store the one or more software artifacts as software artifact data 116 in the memory 110. The one or more software artifacts of the software artifact data 116 may be encrypted by encryption program 114 into an encrypted data file, wherein the first computing device 101 may cause the encrypted data file to be stored at the electronic device 103. The first computing device 101 may generate a public-private key (e.g., asymmetric encryption) associated with the encrypted data file. The first computing device 101 may encrypt the public key and store the public key in the trusted execution environment and encrypt the private key and cause the encrypted private key to be stored at the electronic device 103. In addition, the first computing device 101 may generate policy information associated with the encrypted data file. The policy information may comprise information used for authenticating a receiving device (e.g., a destination server), or person, for authorizing access to the encrypted data file. For example, the policy information may comprise one or more of identifier information of one or more users authorized to access the encrypted data file, identifier information of one or more servers authorized to access the encrypted data file, software authorized to access the encrypted data file, or encryption key information. The first computing device 101 may encrypt the policy information as an encrypted policy file and cause the policy file to be stored at the electronic device 103. In an example, the first computing device 101 may further include a third party software policy manager that generates the policy information. In an example, the first computing device 101 may pre-share the encrypted policy file with the second computing device 102, such as via another electronic device or a secure back-haul network, before the second computing device 102 is provided access to the encrypted data file. In an example, the first computing device 101 may associate signature code with the policy information and the encrypted data file for verifying the encrypted data file.

The second computing device 102 may comprise a server computing device (e.g., a destination server). For example, the second computing device 102 may comprise a digital computer. The digital computer may comprise memory 126, one or more input/output (I/O) interfaces 134, a processor 136, and one or more network interfaces 138. The memory 126, the one or more input/output (I/O) interfaces 134, the processor 136, and the one or more network interfaces 138 may be in communication with each other via a local interface 132. The local interface 132 may comprise one or more buses or other wired or wireless connections. The local interface 132 may comprise additional elements, which are omitted for simplicity, such as controllers, buffers (caches), drivers, repeaters, and receivers, to enable communications. The local interface 132 may further include address, control, and/or data connections to enable appropriate communications among the memory 126, the one or more input/output (I/O) interfaces 134, the processor 136, and the one or more network interfaces 138.

The one or more I/O interfaces 134 may comprise one or more interfaces for receiving user input from, and/or for providing system output to, one or more devices or components. User input may be provided via, for example, a keyboard and/or a mouse. System output may be provided via a display device and a printer (not shown). The I/O interfaces 134 may include, for example, a serial port, a parallel port, a Small Computer System Interface (SCSI), an infrared (IR) interface, a radio frequency (RF) interface, and/or a universal serial bus (USB) interface. In an example, at least one of the one or more I/O interfaces 120 may be configured to connect to the electronic device 103 for accessing the encrypted data file, the encrypted policy file, and/or the encrypted private key.

The processor 136 may be a hardware device for executing software, particularly that may be stored in the memory 126. The processor 136 may be any custom made or commercially available processor, a central processing unit (CPU), an auxiliary processor among several processors associated with the second computing device 102, a semiconductor-based microprocessor (in the form of a microchip or chip set), or generally any device for executing software instructions. When the second computing device 102 is in operation, the processor 136 may be configured to execute software stored within the memory 126, to communicate data to and from the memory 126, and to generally control operations of the second computing device 102 pursuant to the software. In an example, the processor 136 may further include a trusted execution environment comprising a hardware-based memory encryption (e.g., Intel Software Guard Extensions (SGX) CPU). The trusted execution environment may be used to store an authentication key (e.g., secure shell (SSH) key) associated with a user of the second computing device 102. For example, a user of the second computing device 102 may provide user input to the second computing device 102, via the I/O interface 134, requesting an authentication key. The second computing device 102 may generate the decryption key and store the decryption key via the trusted execution environment. In an example, the SSH key may be generated by a third party application/device and provided to the second computing device 102. In an example, the authentication key may only be valid for a period of time (e.g., 10 minutes, 1 hour, 1 week, etc.).

The one or more network interfaces 138 may be used to transmit and receive data from the second computing device 102 via a network (e.g., intranet, extranet, Internet, etc.). The network interface 138 may include, for example, a 10BaseT Ethernet Adaptor, a 100BaseT Ethernet Adaptor, a LAN PHY Ethernet Adaptor, a Token Ring Adaptor, a wireless network adapter (e.g., WiFi, cellular, satellite), or any other suitable network interface device. The one or more network interfaces 138 may include address, control, and/or data connections to enable appropriate communications on the network.

The memory 126 may include any one or combination of volatile memory elements (e.g., random access memory (RAM, such as DRAM, SRAM, SDRAM, etc.)) and nonvolatile memory elements (e.g., ROM, hard drive, tape, CDROM, DVDROM, etc.). Moreover, the memory 126 may incorporate electronic, magnetic, optical, and/or other types of storage media. Note that the memory 126 may have a distributed architecture, wherein various components are situated remote from one another, but may be accessed by the processor 136.

The software in the memory 126 may include one or more software programs, each of which comprises an ordered listing of executable instructions for implementing logical functions. The software in the memory system 126 of the second computing device 102 may comprise an operating system (O/S) 128, and a software application 130. The operating system 128 may control the execution of other computer programs and provide scheduling, input-output control, file and data management, memory management, and communication control, and related services. For example, the second computing device 102 may access the encrypted data file, the encrypted policy file, and/or the encrypted private key via the electronic device 103. The second computing device 102 may use the stored decryption key to decrypt the encrypted policy file, and the encrypted private key. In an example, the software application 130 may be initially encrypted when the second computing device 102 initially receives the software application 130, such as via a third party device. The second computing device 102 may decrypt the encrypted software application 130 based on the authentication key. The second computing device 102 may authenticate the software application based on the policy information. The second computing device 102 may use the authenticated software application to decrypt the encrypted data file based on the private key. In an example, signature code may be associated with the policy information and/or the encrypted data file. The second computing device 102 may further verify the encrypted data file based on the associated signature code. The second computing device 102 may access the one or more software artifacts based on the decrypted data file. In an example, the second computing device 102 may store the one or more software artifacts in a secure location.

As shown in FIG. 1, application programs and other executable program components, such as the operating systems 112/128, are depicted as discrete blocks. However, it is recognized that such programs and components may reside at various times in different storage components of the first computing device 101 and/or the second computing device 102. As an example, the encryption program 114 and/or the software application 130 may be stored on or transmitted across some form of computer readable media. Any of the disclosed methods may be performed by computer readable instructions embodied on computer readable media. Computer readable media may be any available media that can be accessed by a computer. For example, computer readable media may comprise “computer storage media” and “communications media.” “Computer storage media” may comprise volatile and non-volatile, removable and non-removable media implemented in any method or technology for storage of information such as computer readable instructions, data structures, program modules, or other data. In an example, computer storage media may comprise RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

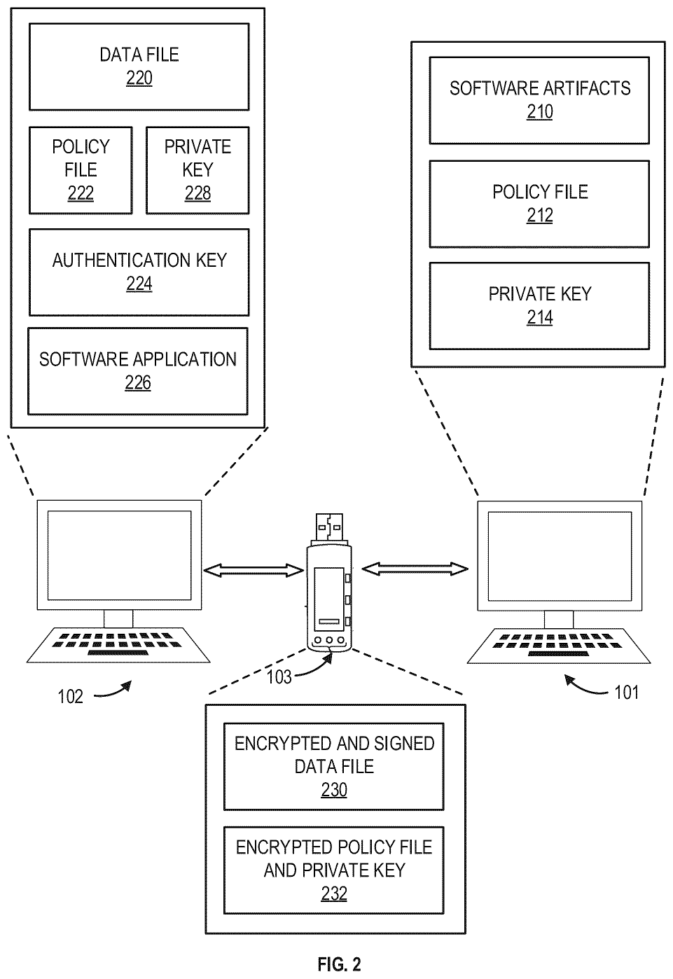

FIG. 2 shows an example scenario for securely transferring software, wherein a first computing device 101 (e.g., secure build server) may provide an encrypted data file, encrypted policy file, and encrypted private key, via an electronic device 103 (e.g., portable storage device such as USB storage, secure digital storage, etc.), to a second computing device 102 (e.g., destination server), wherein the second computing device may decrypt the encrypted data file and access the contents of the data file based on the policy file and private key. The first computing device 101 may receive one or more software artifacts 210 (e.g., data files, container images, or bioinformatics). The first computing device may encrypt the software artifacts into an encrypted data file 230 and associate signature code with the encrypted data file 230. In addition, the first computing device 101 generate and encrypt a policy file 212 and a private key 214 associated with the encrypted data file 230. In an example, the first computing device 101 may generate a public-private key (e.g., asymmetric encryption) associated with the encrypted data file 230. The first computing device 101 may encrypt the public key and store the encrypted public key (e.g., via a trusted execution environment of the first computing device 101) and encrypt the private key and cause the encrypted private key to be stored at the electronic device 103. The second computing device 102 may access the encrypted and signed data file 230 and the encrypted policy file 232 via the electronic device 103. The second computing device 102 receive and store an authentication key 224 (e.g., SSH key) associated with a user of the second computing device 102. For example, the user may provide input requesting an authentication key, wherein the authentication key may be generated by the second computing device 102 or a third party device, for example. The authentication key may only be valid for a period of time (e.g., 10 minutes, 1 hour, 1 week, etc.). The authentication key 224 may be used to decrypt an encrypted software application, the encrypted policy file, and the encrypted private key 232. For example, the second computing device 102 may receive an encrypted software application, wherein the software application 226 may be used to decrypt the encrypted data file 230. The second computing device 102 may authenticate the software application 226 based on the policy file 222. The second computing device 102 may use the authenticated software application 226 to decrypt the encrypted data file based on the private key 228. The second computing device 102 may access the one or more software artifacts based on the decrypted data file 220.

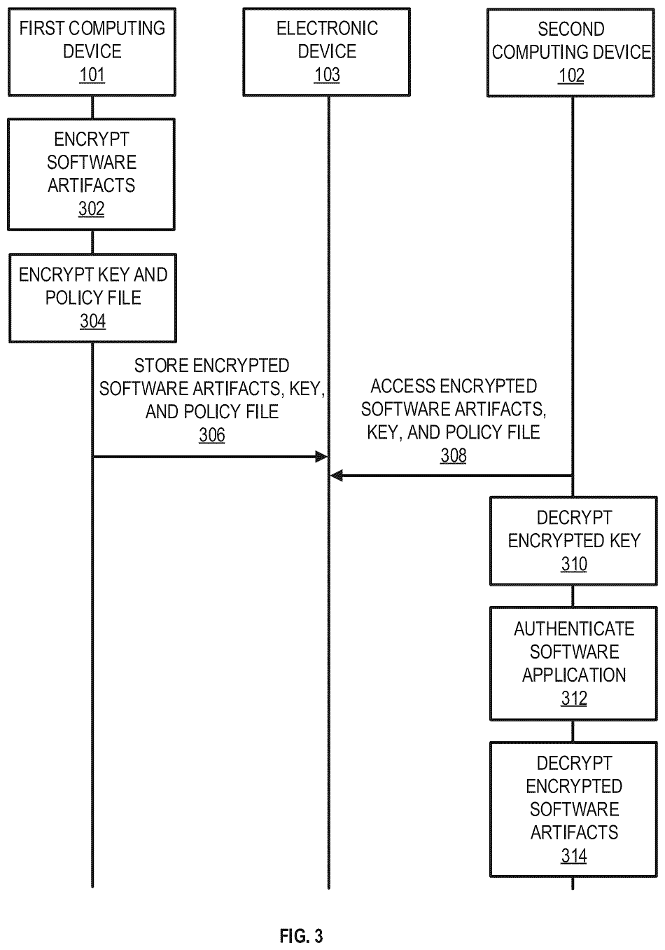

FIG. 3 shows an example process for securely transferring software. At 302, the first computing device 101 (e.g., secure build server) may encrypt one or more software artifacts (e.g., data files, container images, or bioinformatics) into an encrypted data file. At 304, the first computing device 101 may generate and encrypt a private key and a policy file associated with the encrypted data file. The policy file may comprise policy information for authenticating access to the encrypted data file. The policy information may comprise one or more of identifier information of one or more users authorized to access the encrypted data file, identifier information of one or more servers authorized to access the encrypted data file, software authorized to access the encrypted data file, or encryption key information. In an example, the first computing device 101 may generate a public-private key pair (e.g., asymmetric encryption) associated with the encrypted data file. The first computing device 101 may store the public key via a trusted execution environment (e.g., hardware-based memory encryption such as an Intel SGX CPU) of the first computing device 101. At 306, the first computing device 101 may cause the encrypted data file, the encrypted private key, and the encrypted policy file to be stored via the electronic device 103 (e.g., portable storage device such as USB storage, secure digital storage, etc.). At 308, the second computing device 102 (e.g., destination server) may access the encrypted data file, the encrypted private key, and the encrypted policy file via the electronic device 103. At 310, the second computing device 102 may decrypt the encrypted private key, the encrypted policy file, and an encrypted software application based on an authentication key (e.g., SSH key) associated with a user of the second computing device 102. For example, an authentication key may be generated based on a user request. At 312, the second computing device 102 may authenticate the software application based on the policy information. At 314, the second computing device 102 may use the authenticated software application to decrypt the encrypted data file based on the private key and access the one or more software artifacts. In an example, the second computing device 102 may store the one or more software artifacts in a secure location.

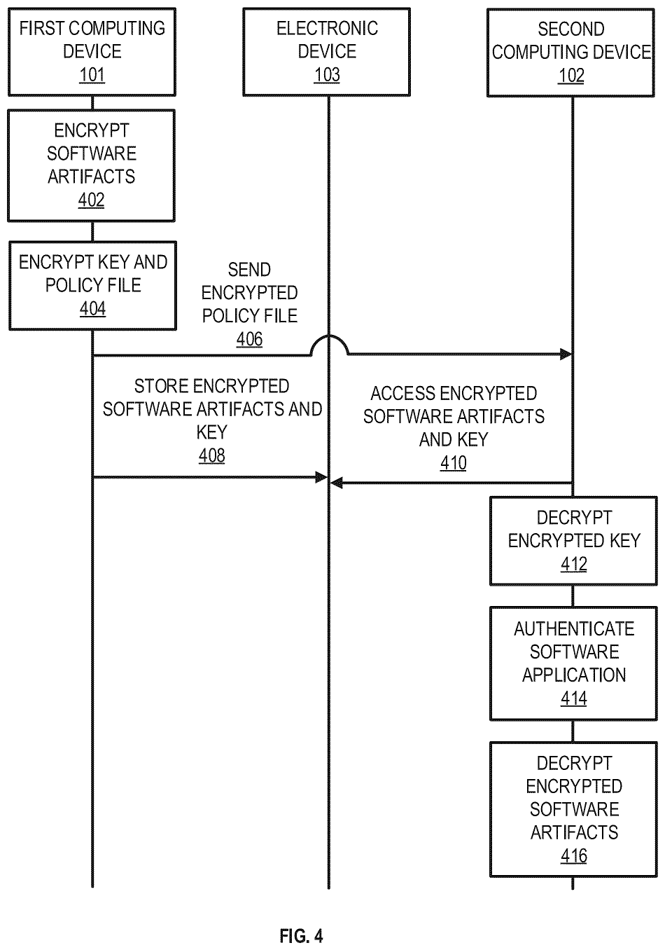

FIG. 4 shows an example process for securely transferring software. Steps 402 and 404 are similar to steps 302 and 304 of FIG. 3. However, an additional step, 406, may be included, wherein the first computing device 101 may send the encrypted policy file directly to the second computing device 102. For example, the first computing device 101 may send the policy file via a secure back-haul network to the second computing device 102. At 408, the first computing device 101 may cause the encrypted data file and the encrypted private key to be stored via the electronic device 103. At 410, the second computing device 102 may access the encrypted data file and the encrypted private key via the electronic device 103. Steps 412, 414, and 416 are similar to steps 310, 312, and 314, respectively, of FIG. 3.

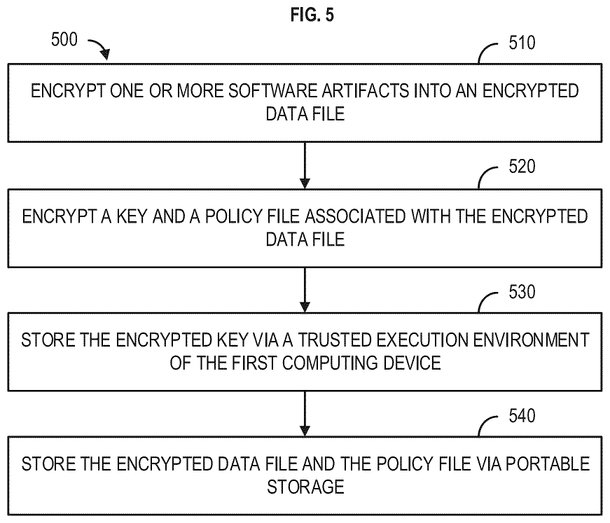

FIG. 5 shows a flowchart of an example method 500. Method 500 may be implemented by the first computing device 101, the second computing device 102, the electronic device 103, any combination thereof, or any other suitable device. At step 510, one or more software artifacts may be encrypted into an encrypted data file. For example, the one or more software artifacts may be encrypted, by the first computing device 101, into the encrypted data file. The first computing device 101, may comprise a secure build server. The one or more software artifacts may comprise one or more of data files, container images, or bioinformatics.

At step 520, a key and a policy file associated with the encrypted data file may be encrypted. For example, the key and the policy file associated with the encrypted data file may be encrypted by the first computing device 101. For example, the key and the policy file may be generated by the first computing device 101 based on the encrypted data file. The key may comprise a private key that may be used to decrypt the encrypted data file. In an example, the first computing device 101 may generate a public key and the private key (e.g., a public-private key pair based on asymmetric encryption) based on the encrypted data file. The policy file may comprise policy information for authenticating access to the encrypted data file. The policy information may comprise one or more of identifier information of one or more users authorized to access the encrypted data file, identifier information of one or more servers authorized to access the encrypted data file, software authorized to access the encrypted data file, or encryption key information. In an example, the first computing device 102 may associate signature code with the policy information and the encrypted data file.

At step 530, the encrypted key may be stored via a trusted execution environment of the first computing device 101. The trusted execution environment may comprise a hardware-based memory encryption (e.g., Intel Software Guard Extensions (SGX) CPU).

At step 540, the encrypted data file and the policy file may be stored via portable storage. For example, the first computing device 101 may cause the encrypted data file and the policy file to be stored via portable storage. The portable storage may be external to the first computing device 101 and the second computing device 102 and may comprise one or more of USB storage, or secure digital storage. In an example, the second computing device 101 may access the encrypted data file via a software application of the second computing device. The software application may be authenticated based on the key and the policy information. For example, the second computing device 102 may access the portable storage to receive the encrypted data file and the encrypted policy file. The second computing device 102 may comprise a second trusted execution environment comprising a hardware-based memory encryption (e.g., Intel Software Guard Extensions (SGX) CPU). The second computing device 102 may store an authentication key, via the trusted execution environment, associated with a user of the second computing device 102. The second computing device 102 may decrypt the encrypted software application, the encrypted policy file, and the encrypted key based on the authentication key. The second computing device 102 may authenticate the software application based on the policy information of the policy file. The second computing device 102 may use the software application to decrypt the encrypted data file based on the authentication of the software application and based on the key and access the one or more software artifacts.

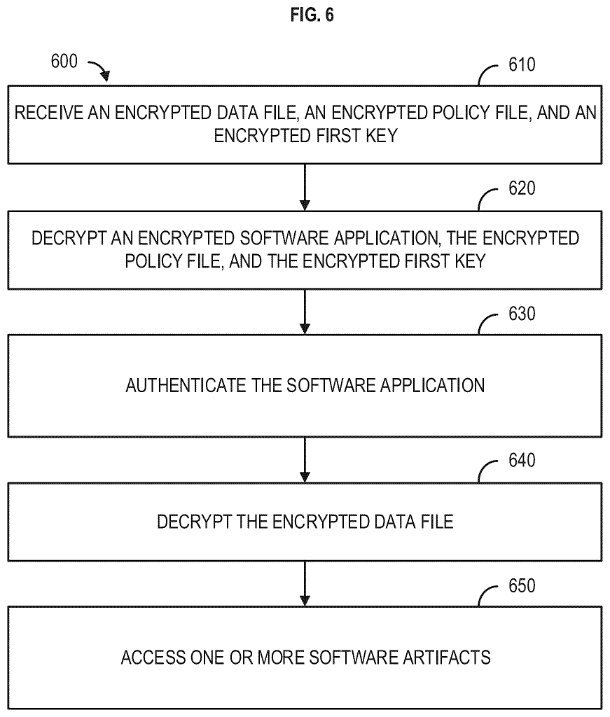

FIG. 6 shows a flowchart of an example method 600. Method 600 may be implemented by the first computing device 101, the second computing device 102, the electronic device 103, any combination thereof, or any other suitable device. At step 610, an encrypted data file, an encrypted policy file, and an encrypted first key may be received. For example, the second computing device 102 may receive the encrypted data file, the encrypted policy file, and the encrypted first key. The second computing device 102 may comprise a destination server. The second computing device 102 may receive the encrypted data file, the encrypted policy file, and the encrypted first key from a secure build server (e.g., the first computing device 101) via portable storage. The portable storage may be external the second computing device 102 and the first computing device 101 and may comprise one or more of USB storage, or secure digital storage.

As an example, the first computing device 101 may encrypt one or more software artifacts into the encrypted data file. In addition, the first computing device 101 may encrypt the first key (e.g., private key), a public key, and the policy file. The first computing device 101 may cause the encrypted data file, the encrypted first key, the encrypted policy file to be stored via the portable storage. In an example, the first computing device may associate signature code with the policy information and the encrypted data file. In an example, the first computing device 101 may pre-share (e.g., send) the encrypted policy file to the second computing device 102 via a secure back-haul network, or network path.

At step 620, a software application, the encrypted policy file, and the encrypted first key may be decrypted based on a second key. For example, the software application, the encrypted policy file, and the encrypted first key may be decrypted by the second computing device 102 based on the second key. For example, the software application may be initially encrypted when the second computing device 102 initially receives the software application, such as via a third party device, for example. In an example, the second computing device 102 may comprise a trusted execution environment comprising a hardware-based memory encryption (e.g., Intel Software Guard Extensions (SGX) CPU). The second computing device 102 may store an authentication key (e.g., the second key), via the trusted execution environment, associated with a user of the second computing device 102. The policy file may comprise policy information for authenticating access to the encrypted data file. The policy information may comprise one or more of identifier information of one or more users authorized to access the encrypted data file, identifier information of one or more servers authorized to access the encrypted data file, software authorized to access the encrypted data file, or encryption key information.

At step 630, the software application may be authenticated based on the policy information. For example, the software application may be authenticated by the second computing device 102 based on the policy information.

At step 640, the encrypted data file may be decrypted via the software application based on the authentication of the software application and based on the first key. For example, the encrypted data file may be decrypted by the second computing device, via the software application, based on the authentication of the software application and based on the first key. In an example, the encrypted data file may be verified by the second computing device 102 based on the signature code associated with the policy information and the encrypted data file. The encrypted data file may be decrypted based on the verification of the encrypted data file.

At step 650, one or more software artifacts may be accessed based on the decrypted data file. For example, the one or more software artifacts may be accessed by the computing device 102 based on the decrypted data file. The one or more software artifacts may comprise one or more software artifacts comprise one or more of data files, container images, or bioinformatics.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

1. A method comprising:
encrypting, by a first computing device, one or more software artifacts into an encrypted data file;
encrypting a key and a policy file associated with the encrypted data file, wherein the policy file comprises policy information for authenticating access to the encrypted data file;
storing the encrypted key via a trusted execution environment of the first computing device; and
storing the encrypted data file and the policy file via portable storage, wherein a second computing device accesses the encrypted data file via a software application of the second computing device that is authenticated based on the key and the policy information.

2. (canceled)

3. (canceled)

4. The method of claim 1, wherein the policy information comprises one or more of identifier information of one or more users authorized to access the encrypted data file, identifier information of one or more servers authorized to access the encrypted data file, software authorized to access the encrypted data file, or encryption key information.

5. The method of claim 1, further comprising associating signature code with the policy information and the encrypted data file.

6. (canceled)

7. (canceled)

8. (canceled)

9. The method of claim 1, wherein the second computing device is configured to decrypt the encrypted key and the encrypted policy file based on a second key associated with the second computing device.

10. A method comprising:
receiving, by a computing device, an encrypted data file, an encrypted policy file, and an encrypted first key;
decrypting, based on a second key, an encrypted software application, the encrypted policy file, and the encrypted first key, wherein the policy file comprises policy information for authenticating access to the encrypted data file;
authenticating, based on the policy information, the software application;
decrypting, via the software application, based on the authentication of the software application and based on the first key, the encrypted data file; and
accessing, based on the decrypted data file, one or more software artifacts.

11. The method of claim 10, wherein the computing device comprises a destination server, wherein the destination server is configured to receive the encrypted data file, the encrypted policy file, and the encrypted first key from a secure build server.

12. The method of claim 10, further comprising receiving, by the computing device, the encrypted data file, the encrypted policy file, and the encrypted first key via portable storage that is external to the computing device:
wherein the portable storage comprises one or more of USB storage, or secure digital storage.

13. (canceled)

14. (canceled)

15. The method of claim 10, wherein the second key is configured to be stored via a trusted execution environment of the computing device.

16. (canceled)

17. The method of claim 10, wherein the policy information comprises one or more of identifier information of one or more users authorized to access the encrypted data file, identifier information of one or more servers authorized to access the encrypted data file, software authorized to access the encrypted data file, or encryption key information.

18. (canceled)

19. The method of claim 10, further comprising verifying, based on signature code associated with the policy information and the encrypted data file, the encrypted data file,
wherein the decrypting of the encrypted data file is based on the verifying of the encrypted data file.

20. (canceled)

21. A system comprising:
a first computing device comprising a trusted execution environment, wherein the first computing device is configured to:
encrypt one or more software artifacts into an encrypted data file;
encrypt a first key and a policy file associated with the encrypted data file, wherein the policy file comprises policy information for authenticating access to the encrypted data file;
store the encrypted first key via the trusted execution environment; and
store the encrypted data file and the encrypted policy file via portable storage; and
a second computing device configured to:
decrypt, based on a second key, an encrypted software application, the encrypted policy file, and the encrypted first key;
authenticate, based on the policy information, the software application;
decrypt, via the software application, based on the authentication of the software application and based on the first key, the encrypted data file; and
access, based on the decrypted data file, the one or more software artifacts.

22. The system of claim 21, wherein the first computing device comprises a secure build server and the second computing device comprises a destination server.

23. The system of claim 21, wherein the trusted execution environment comprises a hardware-based memory encryption.

24. The system of claim 21, wherein the one or more software artifacts comprise one or more of data files, container images, or bioinformatics.

25. The system of claim 21, wherein the policy information comprises one or more of identifier information of one or more users authorized to access the encrypted data file, identifier information of one or more servers authorized to access the encrypted data file, software authorized to access the encrypted data file, or encryption key information.

26. The system of claim 21, wherein the first computing device is further configured to associate signature code with the policy information and the encrypted data file.

27. The system of claim 26, wherein the second computing device is further configured to verify, based on the signature code associated with the policy information and the encrypted data file, the encrypted data file,
wherein the second computing device is further configured to decrypt the encrypted data file based on the verification of the encrypted data file.

28. (canceled)

29. (canceled)

30. The system of claim 21, wherein the portable storage is external to the first computing device and the second computing device, and
wherein the portable storage comprises one or more of USB storage, or secure digital storage.

31. The system of claim 21, wherein the second computing device is further configured to receive the encrypted data file and the policy file via the portable storage.

32. The system of claim 21, wherein the second computing device comprises a second trusted execution environment, wherein the second computing device is further configured to store the second key via the second trusted execution environment.
